(19) United States
(12) Patent Application Publication
(10) Pub. No.: US 2006/0193977 A1
(43) Pub. Date: Aug. 31, 2006

(54) CMOS device featuring high breakdown voltage without failure in enhancing integration thereof, and method for manufacturing such CMOS device

(75) Inventor: Nobuhiro Nagura, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/363,252

(22) Filed: Feb. 28, 2006

(30) Foreign Application Priority Data
Feb. 28, 2005 (JP) 2005-052693

(51) Int. Cl. B05D 1/00

(52) U.S. Cl. 427/209

(57) ABSTRACT

In an complementary metal oxide semiconductor (CMOS) device, a silicon-on-insulator (SOI) substrate structure includes a support substrate, a p⁻-type semiconductor substrate, and an insulating layer sandwiched between the support substrate and the p⁻-type semiconductor substrate. An element-isolation layer is formed in the p⁻-type semiconductor substrate to reach the insulating layer, so that an n-type well region is defined and surrounded by the insulating layer and the element-isolation layer. A p-type MOS transistor is formed in the n-type well region, and an n-type MOS transistor is formed in the first conductivity type semiconductor substrate so as to be adjacent to the n-type well region.

### BACKGROUND OF THE INVENTION

1. Field of the Invention

The present invention relates to a complementary metal oxide semiconductor (CMOS) device, and a method for manufacturing such a CMOS device.

2. Description of the Related Art

A CMOS device includes a p-channel MOS transistor and an n-channel MOS transistor which are formed in a semiconductor substrate so as to be associated with each other.

For example, when the semiconductor substrate is a p⁻-type semiconductor substrate, an element-formation area for forming the p-channel transistor is defined on the p⁻-type semiconductor substrate by an element-isolation layer which is formed therein by using either a localized oxidation of silicon (LOCOS) method or a shallow trench isolation (STI) method. Then, an n-type well region is formed in the element-formation area, and the p-channel transistor is formed in the n-type well region. On the other hand, the n-channel transistor is formed in the p⁻-type semiconductor substrate so as to be adjacent to the n-type well region.

For the formation of the n-type well region, the p⁻-type semiconductor substrate is masked with a photoresist mask so that the element-formation area is exposed to the exterior, and n-type impurities, such as phosphorus ions (P⁺), arsenic ions (As⁺) or the like, are implanted in the exposed element-formation area so that an n-type impurity-implanted region is defined therein. Then, the p⁻-type semiconductor substrate is subjected to an annealing process in which the implanted n-type impurities contained in the n-type impurity-implanted region are activated and diffused, resulting in the formation of the n-type well region in the element-formation area.

Incidentally, before the CMOS device featuring a high breakdown voltage can be obtained, the n-type well region must be deeply formed in the p⁻-type semiconductor substrate, and an impurity density of the n-type well region must be small. Namely, not only must a relatively small amount of the n-type impurities be implanted in the element-formation area on the p⁻-type semiconductor substrate, but also it must be deeply diffused in the semiconductor substrate. This means that an annealing or heating process must be carried out in a so-called drive-in diffusion manner involving a relatively high annealing temperature and a relatively long annealing time.

For example, a CMOS device, which is used in a driver circuit for driving a plasma display panel (PDP) demands a considerably high breakdown voltage falling within a range between 60 volts and 100 volts. In this case, the heating temperature may be 1200° C., and the heating time may be approximately 10 hours.

### SUMMARY OF THE INVENTION

It has now been discovered that the above-mentioned prior art has a problem to be solved as mentioned hereinbelow.

In the drive-in diffusion manner, the n-type impurities are more deeply diffused than the depth or thickness of the element-isolation layer in the p⁻-type semiconductor substrate, and thus they are widely diffused beneath the element-isolation layer so that the n-type well region has an unnecessarily large extent, resulting in failure to enhance the integration of the CMOS device.

JP-2001-196470-A discloses another prior art process for forming a CMOS device featuring a high breakdown voltage (from 12 to 15 volts) and a COMS device featuring a low breakdown voltage (from 2.5 to 5 volts) in a semiconductor substrate. Nevertheless, by this prior art process, it is difficult to form the aforesaid CMOS device featuring the considerably high breakdown voltage (from 60 to 100 volts) without enhancing the integration of CMOS device for similar reasons to those as stated above.

In accordance with a first aspect of the present invention, there is provided a complementary metal oxide semiconductor (CMOS) device. In the COMS device, a substrate structure includes a support substrate, a first conductivity type semiconductor substrate, and an insulating layer sandwiched between the support substrate and the first conductivity type semiconductor substrate. An element-isolation layer is formed in the first conductivity type semiconductor substrate to reach the insulating layer, so that a second conductivity type well region is defined and surrounded by the insulating layer and the element-isolation layer. A first conductivity type MOS transistor is formed in the second conductivity type well region, and a second conductivity type MOS transistor formed in the first conductivity type semiconductor substrate so as to be adjacent to the second conductivity type well region.

The second conductivity type well region has a low impurity density and a depth reaching the insulating layer so that that the first conductivity type MOS transistor features a high breakdown voltage, which may fall within a range from approximately 60 to approximately 100 volts.

Also, the first conductivity type substrate may have a low impurity density so that that the second conductivity type MOS transistor features a high breakdown voltage, which may fall within a range from approximately 60 to approximately 100 volts.

The element-isolation layer may be formed as an insulating layer, which is obtained by forming a trench reaching the sandwiched insulating layer in the first conductivity type semiconductor substrate, and by stuffing the trench with insulator, using a chemical vapor deposition process. Optionally, the element-isolation layer may be formed as a composite layer, which is obtained by forming a trench reaching the sandwiched insulating layer in the first conductivity type substrate, by forming an oxide layer on an inner wall face of the trench, using a thermal oxidization process, and by stuffing the trench with polycrystalline silicon, using a chemical vapor deposition process.

The element-isolation layer may have a width falling within a range from approximately 0.5 to 3 μm.

In accordance with a second aspect of the present invention, there is provided a method for manufacturing an complementary metal oxide semiconductor (CMOS) device, which method comprises the steps of: preparing a substrate structure including a support substrate, a first conductivity type semiconductor substrate, and an insulating layer sandwiched between the support substrate and the first conductivity type semiconductor substrate; forming a trench in the first conductivity type semiconductor substrate so that an element-formation region is defined therein, and so that the trench reaches the insulating layer; stuffing the trench with an insulating material so as to form an element-isolation layer; implanting second conductivity type impurities in the element-formation region so that an impurity-implanting region is formed therein; subjecting the substrate structure to an annealing process so that the second conductivity type impurities are activated and diffused in a drive-in manner in the element-formation region, resulting in reformation of the whole element-formation region into a second conductivity type well region; forming a first conductivity type MOS transistor in the second conductivity type well region; and forming a second conductive type MOS transistor in the first conductivity type substrate so as to be adjacent to the second conductivity type well region.

### BRIEF DESCRIPTION OF THE DRAWINGS

The above objects and other objects will be more clearly understood from the description set forth below, with reference to the accompanying drawings, wherein:

FIGS. 1A through 1M are partial cross-sectional views for explaining an embodiment of the method for manufacturing a high breakdown voltage type CMOS device according to the present invention;

FIGS. 2A through 2D are partial cross-sectional views for explaining a modification of the manufacturing method of FIGS. 1A through 1M;

FIGS. 3A through 3D are partial cross-sectional views for explaining the effects or advantages of the present invention;

FIG. 4A is a block circuit diagram illustrating a scanning driver circuit for a plasma display panel, in which the CMOS device of FIGS. 1A through 1M is be used; and

FIG. 4B is a block circuit diagram representatively illustrating one of the CMOS devices of the high voltage switching circuit of FIG. 4A.

### DESCRIPTION OF THE PREFERRED EMBODIMENTS

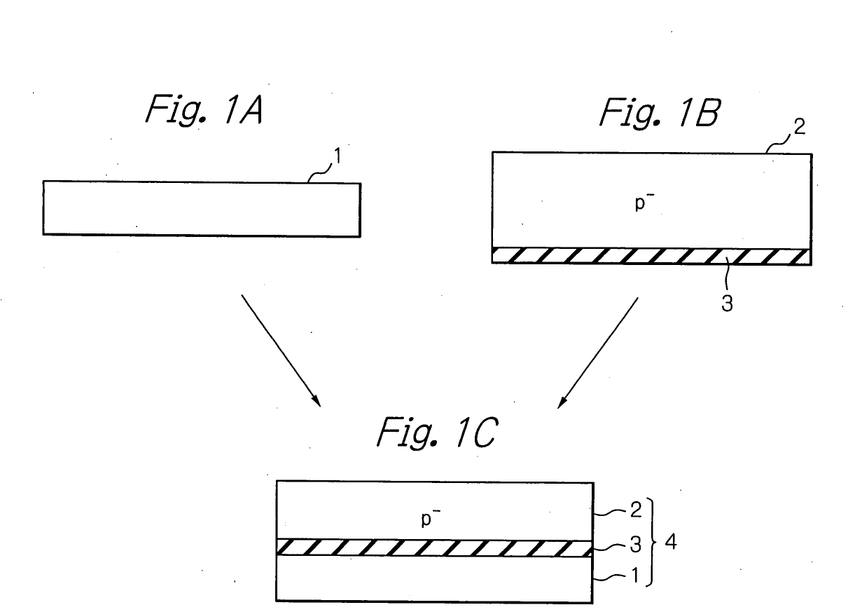

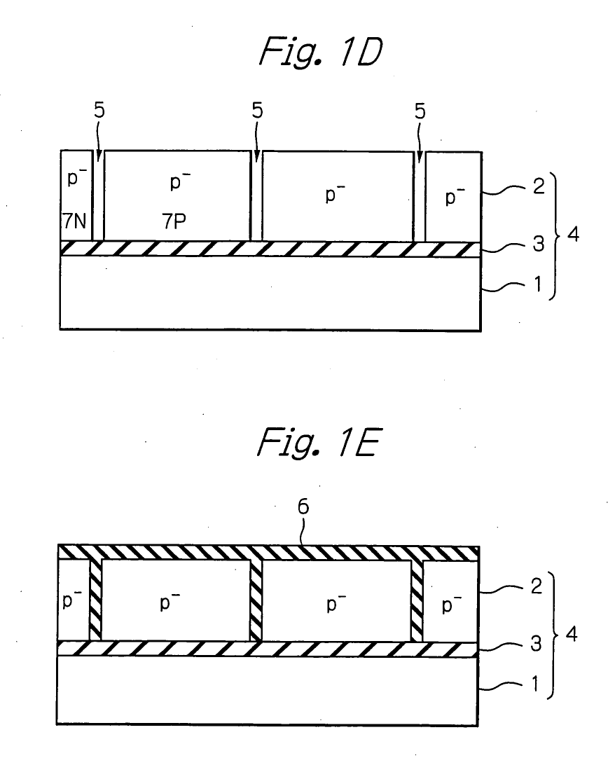

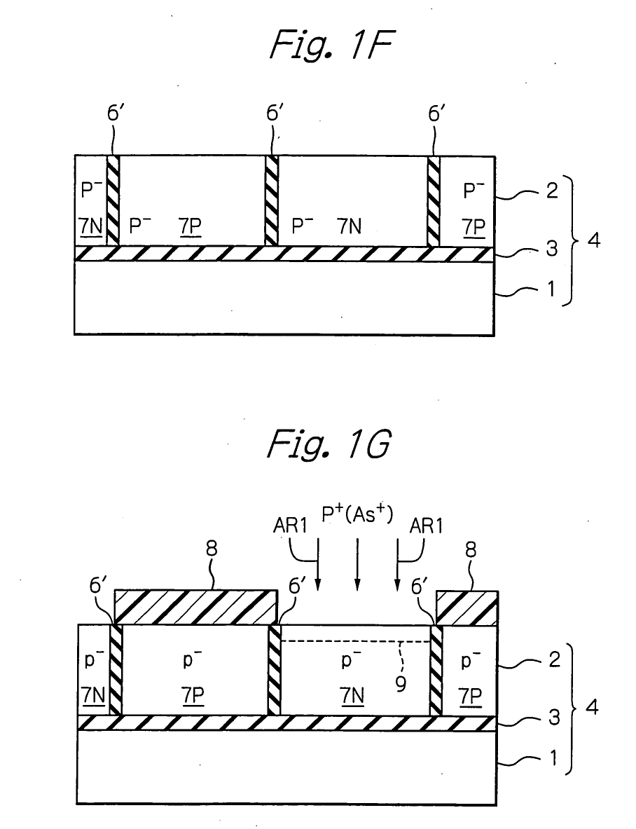

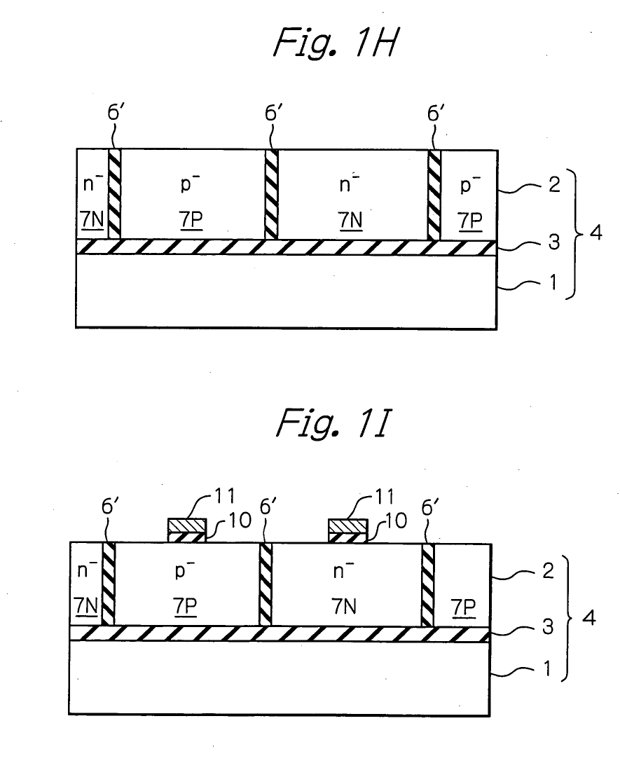

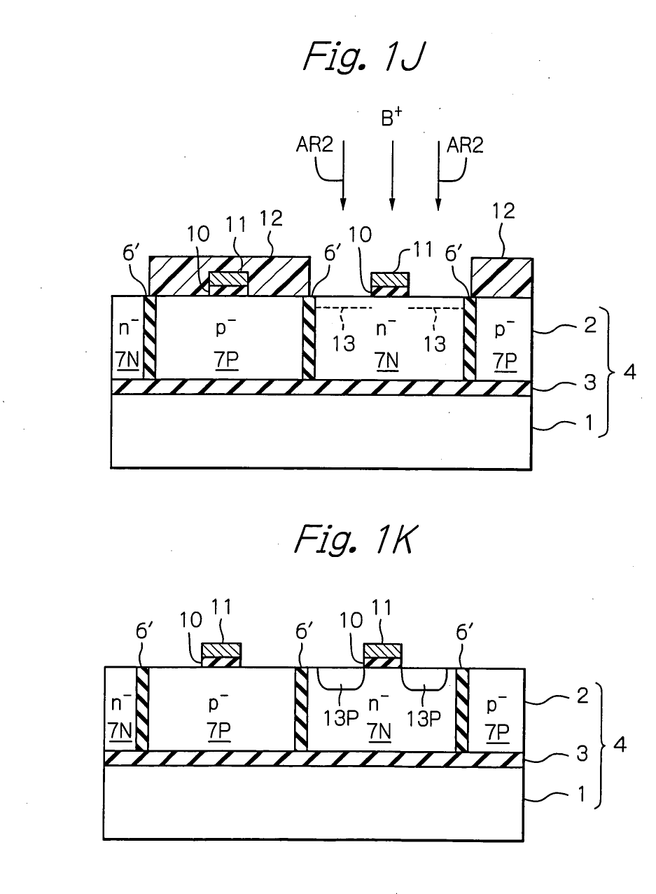

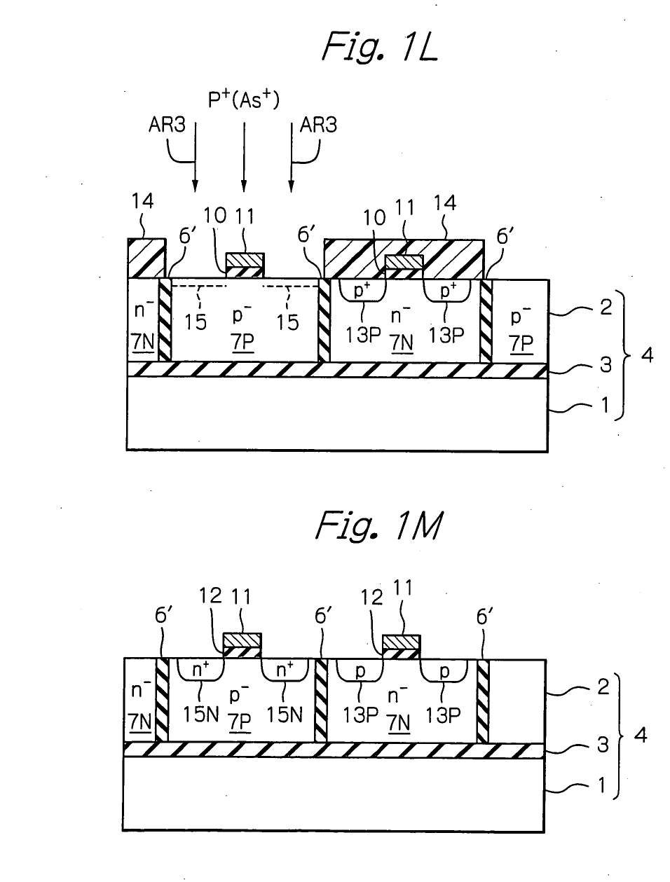

With reference to FIGS. 1A through 1M, an embodiment of the method for manufacturing a high breakdown voltage type CMOS device according to the present invention is explained below.

First, referring to FIG. 1A, a support substrate 1, which may be derived from a suitable semiconductor wafer such as a silicon wafer, is prepared.

On the other hand, referring to FIG. 1B, a p⁻-type semiconductor substrate 2 is prepared. Similar to the support substrate 1, the p⁻-type semiconductor substrate 2 may be derived from a p⁻-type silicon wafer. Then, a silicon dioxide layer 3 is formed as an insulating layer on one surface of the p⁻-type semiconductor substrate 2 by using a thermal oxidization process.

As shown in FIG. 1C, the p⁻-type semiconductor substrate 2 is placed on the support substrate 1 so that the silicon dioxide layer 3 is in contact with a surface of the support substrate 1. Namely, the silicon dioxide layer 3 is sandwiched between the support substrate 1 and the p⁻-type semiconductor substrate 2. Then, the silicon dioxide layer 3 is thermally adhered to the support substrate 1, and thus a silicon-on-insulator (SOI) substrate structure 4 is obtained by the support substrate 1, the p⁻-type semiconductor substrate 2 and the silicon dioxide layer 3. Subsequently, the p⁻-type semiconductor substrate 2 is polished by using a chemical mechanical polishing (CMP) process, until the p⁻-type semiconductor substrate 2 has a suitable thickness, for example, 5 μm.

Note, although the silicon dioxide layer 3 is formed on the surface of the p⁻-type semiconductor substrate 2, it may be formed on the support substrate 1. Also, note, when the silicon dioxide layer 3 is formed on the support substrate, the p⁻-type semiconductor substrate 2 may be formed as an p⁻-type epitaxial silicon layer on the silicon dioxide layer 3.

Next, referring to FIG. 1D, a plurality of trenches 5 are formed in the p⁻-type semiconductor substrate 2 by using a photolithography and etching process, so that each of the trenches 5 reaches a surface of the silicon dioxide layer 3. Namely, the surface of the silicon dioxide layer 3 is partially exposed to the exterior by the formation of the trenches 5. Note, the trenches 5 may have a width falling within a range from 0.5 to 3 μm.

Next, referring to FIG. 1E, the trenches 5 are stuffed with an insulating material such as a silicon dioxide material by using a chemical vapor deposition (CVD) process, with a top surface of the p⁻-type semiconductor substrate 2 being coated with the silicon dioxide material to thereby form a silicon dioxide layer 6 thereon. Namely, the silicon dioxide layer 6 includes the portions of silicon dioxide with which the trenches 5 are stuffed.

Next, referring to FIG. 1F, the silicon dioxide layer 6 is polished by using a CMP process to thereby remove the redundant material from the silicon dioxide layer 6, so that the portions of silicon dioxide, with which the trenches 5 are stuffed, remain as element-isolation layers 6′ reaching the surface of the silicon dioxide layer 3. Thus, a plurality of element-formation regions 7N and 7P are defined in the p⁻-type semiconductor substrate 2 by the element-isolation layers 6′.

Note, as stated hereinafter, each of the element-formation regions 7N is defined as an n-type well region for forming a p-channel type MOS transistor, and each of the element-formation regions 7P remains as a p-type well region for forming an n-channel type MOS transistor.

Next, referring to FIG. 1G, a photoresist mask 8 is formed on the p⁻-type semiconductor substrate 2, and is patterned by using a photolithography and etching process such that each of the element-formation regions 7N is exposed to the exterior. Then, n-type impurities, such as phosphorus ions (P⁺), arsenic ions (As⁺) or the like, are implanted into the exposed element-formation region 7N at about 5×10⁻¹² ions/cm², as symbolically represented by arrows AR1, so that an n-type impurity-implanted region 9 is defined therein. At this time, an impurity density of the n-type impurity-implanted region 9 is selected in accordance with a previously determined high breakdown voltage of the p-channel type MOS transistor to be formed in the element-formation region 7N. Then, the patterned photoresist layer 9 is removed from the surface of the p⁻-type semiconductor substrate 2 by using an ashing process, a wet peeling process or the like.

Next, referring to FIG. 1H, the SOI substrate structure 4 is subjected to an annealing or heating process in which the implanted n-type impurities contained in the n-type impurity-implanted region 9 (see: FIG. 1G) are activated and diffused in the element-formation region 7N in a so-called drive-in diffusion manner. Namely, the annealing process is carried out at a relatively high heating temperature over a relatively long heating time. For example, the heating temperature is approximately 1200° C., and the heating time is approximately 10 hours. Note that the heating time is adjustable within a time range from 4 hours to 20 hours.

In short, the drive-in diffusion of the implanted n-type impurities is carried out in the element-formation region 7N, so that the whole element-formation region 7N is reformed as the n-type well region for forming the p-channel type MOS transistor. During the reformation of the whole element-formation region 7N into the n-type well region, the diffusion of the n-type impurities from the n-type well region 7N concerned into the adjacent element-formation regions or n-type well regions 7P can be prevented, due to the existence of the element-isolation layers 6′ reaching the surface of the silicon dioxide layer 3.

Next, referring to FIG. 1I, a gate insulating layer is formed on the surfaces of the respective n-type and p-type well regions 7N and 7P by using a thermal oxidization process. Then, a gate electrode layer is formed on the surface of the gate insulating layer by using a sputtering process. Then, the gate electrode layer is patterned by a photolithography and etching process to obtain gate electrode layers 11. Subsequently, the gate insulating layer is patterned in self-alignment with the gate electrode layers 11 to obtain gate insulating layers 10.

Next, referring to FIG. 1J, a photoresist layer 12 is formed on the top surface of the p⁻-type semiconductor substrate 2, and is patterned by using a photolithography and etching process such that each of the n-type well regions 7N is exposed to the exterior. Then, p-type impurities, such as boron ions (B⁺) or the like, are implanted into the exposed n-type well region 7N, symbolically represented by arrows AR2, so that p-type impurity-implanted regions 13 are defined therein. Subsequently, the patterned photoresist layer 12 is removed from the surface of the p⁻-type semiconductor substrate 2 by using an ashing process, a wet peeling process or the like.

Next, referring to FIG. 1K, the SOI substrate structure 4 is subjected to an annealing process in which the implanted p-type impurities contained in the p-type impurity-implanted regions 13 (see: FIG. 1J) are activated and diffused at a suitable annealing temperature over a suitable annealing time, so that p-type impurity-diffusion regions 13P are defined as source/drain regions in the n-type well region 7N, resulting in formation of the p-channel type MOS transistor featuring a high breakdown voltage which falls within a range from 60 to 100 volts.

Note, although not illustrated, lightly doped drains (LDD) may be formed in the n-type well region 7N so as to be associated with the respective p-type impurity-diffusion regions 13P.

Next, referring to FIG. 1L, a photoresist layer 14 is formed on the surface of the p⁻-type semiconductor substrate 2, and is patterned by using a photolithography and etching process such that each of the p-type well regions 7P is exposed to the exterior. Then, n-type impurities, such as phosphorus ions (P⁺), arsenic ions (As⁺) or the like, are implanted into the exposed p-type well region 7P, symbolically represented by arrows AR3, so that n-type impurity-implanted regions 15 are defined therein. Subsequently, the patterned photoresist layer 14 is removed from the surface of the p⁻-type semiconductor substrate 2 by using an ashing process, a wet peeling process or the like.

Next, referring to FIG. 1M, the SOI structure is subjected to an annealing process in which the implanted n-type impurities contained in the n-type impurity-implanted regions 15 (see: FIG. 1L) are activated and diffused at a suitable annealing temperature over a suitable annealing time, so that n-type impurity-diffusion regions 15N are defined as source/drain regions in the p-type well region 7P, resulting in formation of the n-channel type MOS transistor featuring a high breakdown voltage which falls within a range from 60 to 100 volts. Namely, an impurity density of the p-type semiconductor substrate 2 is previously selected so that the high breakdown voltage (from 60 to 100 volts) can be set in the n-channel type MOS transistor.

Note, although not illustrated, lightly doped drains (LDD) may be formed in the n-type well region 7N so as to be associated with the respective p-type impurity-diffusion regions 13P.

Thus, the formation of the CMOS device in the SOI substrate structure 4 according to the present invention is completed. As shown in FIG. 1M, since the p-channel type MOS transistor and the n-channel type MOS transistor are isolated from each other by the fine element-isolation layers 6′ having the width from 0.5 μμm to 3 μm, it is possible to considerably enhance the integration of the CMOS device according to the present invention.

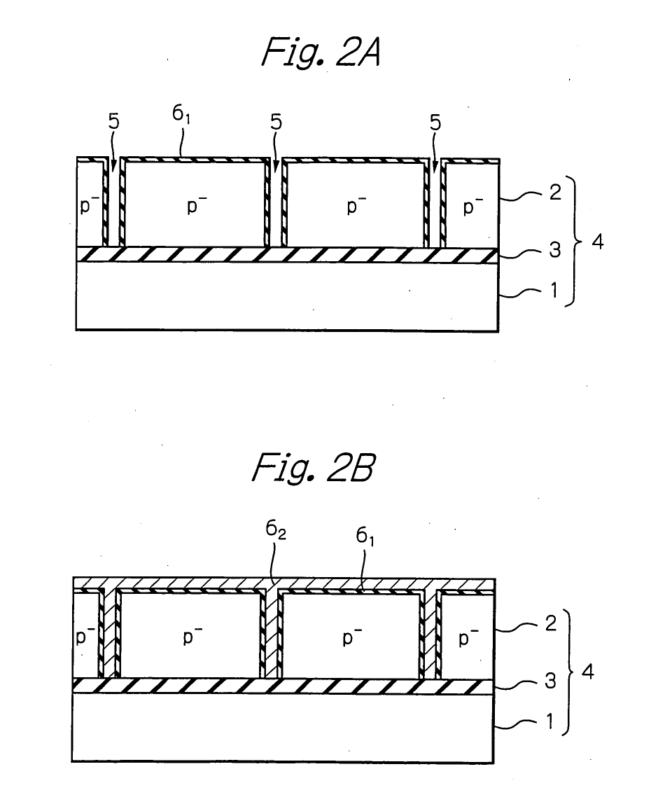

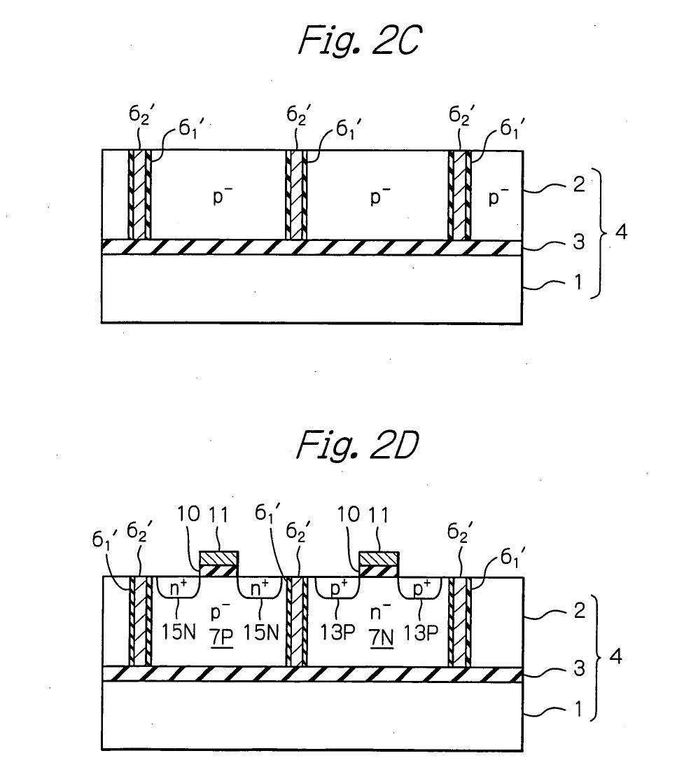

FIGS. 2A through 2D show a modification of the above-mentioned manufacturing method of FIGS. 1A through 1M.

Referring to FIG. 2A, in this modification, after the trenches 5 are formed in the p⁻-type semiconductor device 2, a silicon dioxide layer 6₁ is formed on a top surface of the p⁻-type semiconductor substrate 2 and inner wall faces of the trenches 5 by using a thermal oxidization process.

Next, referring to FIG. 2B, the trenches 5 are stuffed with a polycrystalline silicon material by using a CVD process, with the top surface of the p⁻-type semiconductor substrate 2 being coated with the polycrystalline silicon material to thereby form a polycrystalline silicon layer 6₂ thereon. Namely, the polycrystalline silicon layer 6₂ includes the portions of polycrystalline silicon with which the trenches 5 are stuffed.

Next, referring to FIG. 2C, both the polycrystalline silicon layer 6₂ and the silicon dioxide layer 6₁ are polished by using a CMP process to thereby remove the redundant materials from both the polycrystalline silicon layer 6₂ and the silicon dioxide layer 6₁, so that the portions of silicon dioxide, which are formed on the inner wall faces of the trenches 5, remain as silicon dioxide layers 6₁′, and so that the portions of polycrystalline silicon, with which the trenches 5 are stuffed, remain as polycrystalline silicon layers 6₂′. Namely, in the modification, each of the element-isolation layers is formed as a composite layer composed of a silicon dioxide layer 6₁′ and a polycrystalline silicon layer 6₂′ on the silicon dioxide layer 6₁′. Thus, a plurality of element-formation regions 7N and 7P are defined in the p⁻-type semiconductor substrate 2 by the element-isolation layers (6₁′, 6₂′).

As shown in FIG. 2D corresponding to FIG. 1M, a CMOS device according to the present invention is formed in the SOI substrate structure 4 by carrying out the steps as explained with reference to FIGS. 1G through 1M.

In the modification, during the drive-in diffusion of the implanted n-type impurities in the element-formation region 7N, i.e., during the reformation of the whole element-formation region 7N into the N-type well region, the diffusion of the n-type impurities from the n-type well region 7N concerned into the adjacent n-type well regions 7P can be well prevented due to the existence of the silicon dioxide layers 6₁′ obtained by the thermal oxidization process.

In general, it is difficult to compactly stuff a fine deep trench with silicon dioxide by using a CVD process, but it is easy to compactly stuff the fine deep trench with polycrystalline silicon by using a CVD process. Thus, the modified embodiment of FIGS. 2A through 2D suits a case where a width of the trenches 5 is relatively small.

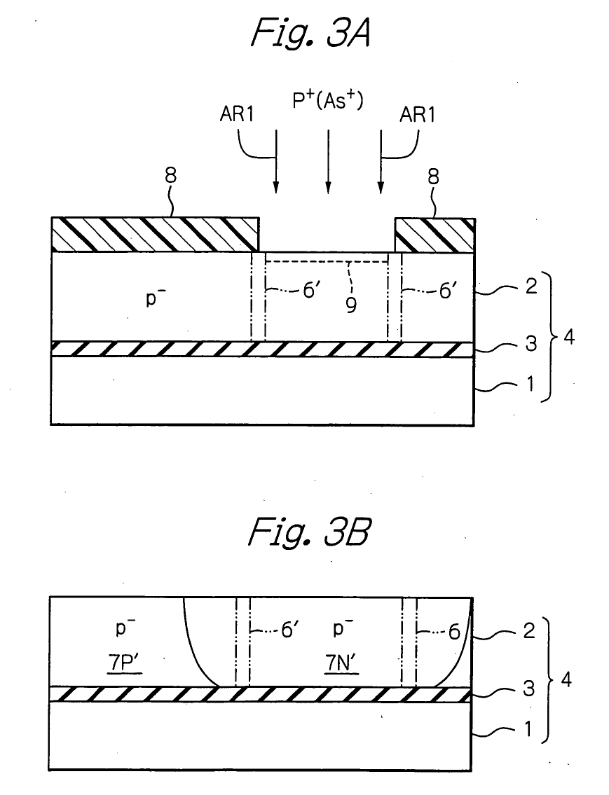

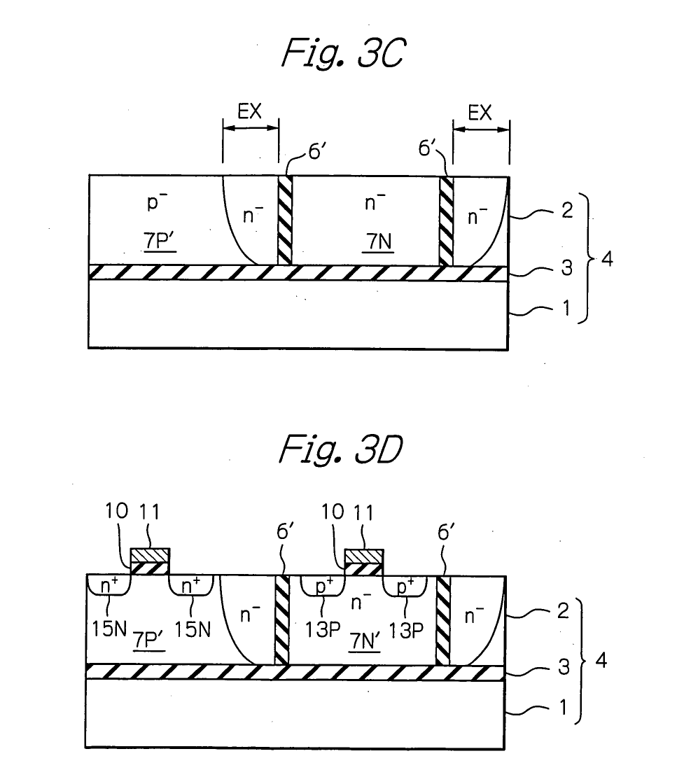

FIGS. 3A through 3D are partial cross-sectional views for explaining the effects or advantages of the present invention.

As shown in FIG. 3A, when the formation of the n-type impurity-implanted region 9 is carried out, using the patterned photoresist layer 8, prior to the formation of the element-isolation layer 6′, it is impossible to enhance the integration of the CMOS device as stated hereinafter.

As shown in FIG. 3B, when the SOI substrate structure 4 is subjected to the annealing or heating process in which the implanted n-type impurities contained in the n-type impurity-implanted region 9 are activated and diffused in the so-called drive-in manner at the high heating of temperature (1200° C.) over a long time (10 hours), an n-type well region 7N′, which is obtained by the drive-in diffusion of the n-type impurities, is widely and deeply extended due to no formation of the element-isolation layer 6′.

Thereafter, as shown in FIG. 3C, although the element-isolation layers 6′ are formed in the semiconductor substrate 2, the n-type well region 7N′ already trespasses on an adjacent p-type well region 7P′, so that a virtual extent, indicated by reference EX, is added to each of the element-isolation layers 6′.

Thus, as shown in FIG. 3D, when the p-channel type MOS transistor and the n-channel type MOS transistor are formed in the respective n-type and p-type well regions 7N′ and 7P′, these transistors are spaced away from each other by a distance corresponding to the total of the extent and the width of the element-insulation layer 6′, resulting in failure to enhance the integration of the CMOS device.

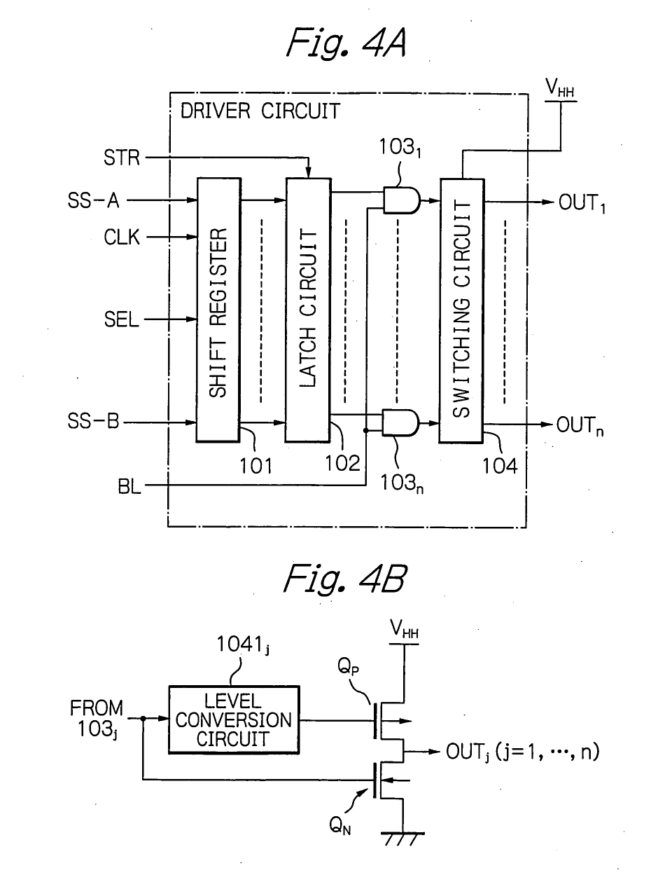

FIG. 4A is a block circuit diagram showing a scanning driver circuit for driving scan lines on a plasma display panel (PDP), in which the aforesaid CMOS device according to the present invention can be used.

In FIG. 4A, the scanning driver circuit includes a shift register 101, a latch circuit 102, a plurality of AND-gates 103₁, . . . , 103ₙ, and a high voltage switching circuit 104. Note that the number of the AND-gates 103₁, . . . , 103ₙ corresponds to a number of the scan lines on the PDP.

The shift register 101 is provided with first and second input ports for receiving respective scan start signals SS-A and SS-B, which are output as pulse signals from a system control circuit (not shown) for the PDP. Also, the shift register 101 is arranged to receive a selection signal SEL and a clock signal CLK from the system control circuit. In operation, only one of the scan start signals SS-A and SS-B is used. Namely, it is determined by the selection signal SEL which scan start signal (SS-A or SS-B) should be selected.

For example, in a case where the scan start signal SS-A is selected, when the scan start signal SS-A is input to the first input port of the shift register 101, it is held as a logic signal “1” in the shift register 101. The logic signal “1” is shifted toward the second input port of the shift register 101 in accordance with the clock signal CLK.

Similarly, in a case where the scan start signal SS-B is selected, when the scan start signal SS-B is input to the second input port of the shift register 101, it is held as a logic signal “1” in the shift register 101, with the remaining logic signals held in the shift register 101 being defined as “0”. The logic signal “1” is shifted toward the first input port of the shift register 101 in accordance with the clock signals CLK.

The latch circuit 102 is arranged to receive a strobe signal STR from the system control circuit, and the strobe signal STR is transmitted from the system control circuit to the latch circuit 102 after every one pulse of the clock signal CLK is input to the shift register 101. Upon receiving the strobe signal STR by the latch circuit 102, the latch circuit 102 fetches the logic signal “1” and the logic signals “0” from the shift register 101, and the fetched logic signals are latched until the latch circuit 102 receives the next strobe signal STR.

The AND-gates 103₁, . . . , 103ₙ are arranged to receive a scanning pulse signal BL carrying a basic luminance signal from the system control circuit. When the scanning pulse signal BL are input to the AND-gates 103₁, . . . , 103ₙ, only one AND-gate 103_{j(j=1, . . . , n)} to which the logic signal “1” is output from the latch circuit 102, outputs a logic signal “1” to the high voltage switching circuit 104, and the remaining AND-gates 103ⱼ input logic signals “0” to the high voltage switching circuit 104.

The high voltage switching circuit 104 includes a plurality of CMOS devices (switches), which are formed according to the present invention, and a high voltage V_{HH} (e.g. 70 volts) is applied to all the CMOS devices. When the AND-gate 103_{j(j=1, . . . , n)} concerned outputs the logic signal “1” to the corresponding CMOS device, this CMOS device outputs a drive signal OUT_{j(j=1, . . . , n)} of 70 volts to the PDP, so that a corresponding scan line on the PDP is made to V_{HH}, with the remaining CMOS devices outputting the drive signals of 0 volts.

Referring to FIG. 4B which is a block circuit diagram representatively illustrating one of the CMOS devices of the high voltage switching circuit 104 of FIG. 4A, the CMOS device includes a p-channel transistor Q_{P} and an n-channel transistor Q_{N} associated with a level conversion circuit 1041ⱼ. The high voltage V_{HH} is applied to the source of the p-channel transistor Q_{P}, and the source of the n-channel transistor Q_{N} is grounded.

When the logic signal “1” or high level signal is input from the level conversion circuit 1041ⱼ to both the gates of the p-channel and n-channel transistors Q_{P} and Q_{N}, the p-channel transistor Q_{P} is turned ON, and the n-channel transistor Q_{P} is turned OFF, whereby the drive signal OUTⱼ of 70 volts is output from the CMOS device.

When the logic signal “0” or low level signal is input from the level conversion circuit 1041ⱼ to both the gates of the p-channel and n-channel transistors Q_{P} and Q_{N}, the p-channel transistor Q_{P} is turned OFF, and the n-channel transistor Q_{P} is turned ON, whereby the drive signal OUTⱼ of 0 volts is output from the CMOS device.

In the above-mentioned embodiment, although the n-channel transistor formed in the p-type well region 7P features high breakdown voltage, the n-channel transistor may have a low breakdown voltage, if necessary. In this case, the p-type impurity density of the p-type semiconductor substrate 2 must be increased so that the n-channel type MOS transistor features the low breakdown voltage.

Also, in the above-mentioned embodiment, CMOS devices featuring a low breakdown voltage are incorporated in another area on the SOI substrate structure 4.

Finally, it will be understood by those skilled in the art that the foregoing description is of preferred embodiments of the devices and methods, and that various changes and modifications may be made to the present invention without departing from the spirit and scope thereof.

1. A complementary metal oxide semiconductor (CMOS) device comprising:
a support substrate;
a first conductivity type semiconductor substrate;
an insulating layer sandwiched between said support substrate and said first conductivity type semiconductor substrate;
an element-isolation layer formed in said first conductivity type semiconductor substrate to reach the insulating layer, so that a second conductivity type well region is defined and surrounded by said insulating layer and said element-isolation layer;
a first conductivity type MOS transistor formed in said second conductivity type well region; and
a second conductivity type MOS transistor formed in said first conductivity type semiconductor substrate so as to be adjacent to said second conductivity type well region.

2. The CMOS device as set forth in claim 1, wherein said second conductivity type well region has a low impurity density, and reaches said insulating layer, so that said first conductivity type MOS transistor features a high breakdown voltage.

3. The CMOS device as set forth in claim 1, wherein said first conductivity type substrate has a low impurity density so that that said second conductivity type MOS transistor features a high breakdown voltage.

4. The CMOS device as set forth in claim 1, wherein said element-isolation layer is formed as an insulating layer, which is obtained by forming a trench reaching said sandwiched insulating layer in said first conductivity type semiconductor substrate, and by stuffing said trench with insulator.

5. The CMOS device as set forth in claim 1, wherein said element-isolation layer is formed as a composite layer, which is obtained by forming a trench reaching said sandwiched insulating layer in said first conductivity type substrate, by forming an oxide layer on an inner wall face of said trench, and by stuffing said trench with polycrystalline silicon.

6. The CMOS device as set forth in claim 1, wherein said element-isolation layer has a width falling within a range from approximately 0.5 to approximately 3 μm.

7. A method for manufacturing an complementary metal oxide semiconductor (CMOS) device, which method comprises:
preparing a substrate structure including a support substrate, a first conductivity type semiconductor substrate, and an insulating layer sandwiched between said support substrate and said first conductivity type semiconductor substrate;
forming a trench in said first conductivity type semiconductor substrate so that an element-formation region is defined therein, and so that said trench reaches said insulating layer;
stuffing said trench with an insulating material so as to form an element-isolation layer;
implanting second conductivity type impurities in said element-formation region so that an impurity-implanting region is formed therein;
subjecting said substrate structure to a heating process so that said second conductivity type impurities are activated and diffused in a drive-in manner in said element-formation region, resulting in reformation of said whole element-formation region into a second conductivity type well region;
forming a first conductivity type MOS transistor in said second conductivity type well region; and
forming a second conductive type MOS transistor in said first conductivity type substrate so as to be adjacent to said second conductivity type well region.

8. The method as set forth in claim 7, wherein said second conductivity type well region has a low impurity density and a depth reaching said insulating layer so that that said first conductivity type MOS transistor features a high breakdown voltage.

9. The method as set forth in claim 7, wherein said first conductivity type substrate has a low impurity density so that that said second conductivity type MOS transistor features a high breakdown voltage.

10. The method as set forth in claim 7, wherein the formation of said element-isolation layer is carried out by stuffing said trench with insulator, using a chemical vapor deposition process.

11. The method as set forth in claim 7, wherein the formation of said element-isolation layer is carried out by forming an oxide layer on an inner wall face of said trench, using a thermal oxidization process, and by stuffing said trench with polycrystalline silicon, using a chemical vapor deposition process.

12. The method as set forth in claim 7, wherein said element-isolation layer has a width falling within a range from approximately 0.5 to approximately 3 μm.
